(19) United States
(12) Patent Application Publication
(10) Pub. No.: US 2015/0288864 A1
(43) Pub. Date: Oct. 8, 2015

(54) PROCESS AND DEVICE FOR CAPTURING AND RENDERING A PANORAMIC OR STEREOSCOPIC STREAM OF IMAGES

(71) Applicant: GIROPTIC, Lille (FR)

(72) Inventor: Richard Ollier, La Madeleine (FR)

(21) Appl. No.: 14/443,097

(22) PCT Filed: Nov. 12, 2013
(86) PCT No.: PCT/FR2013/052707

§ 371 Date: May 15, 2015

(30) Foreign Application Priority Data
Nov. 15, 2012 (FR) 1260880

(51) Int. Cl. H04N 5/225; H04N 13/02; H04N 5/232

(52) U.S. Cl. CPC H04N 5/2258; H04N 5/23238; H04N 5/23229; H04N 13/0242; H04N 13/0282

(57) ABSTRACT

To capture and render a stream of panoramic or stereoscopic images of a scene, using at least one image capture device several successive capture operations are performed of at least two different images of a scene, in pixel format, with or without overlap of the images, the image capture operations occurring at a frequency rate which defines a capture time between the beginning of two successive capture operations. For each capture operation, the pixels of the captured image are digitally processed so as to form a final panoramic or stereoscopic image using said pixels, with a processing time that is less than or equal to said capture time, and during an interval of time that is less than or equal to the captured time, a final and previously formed panoramic or stereoscopic image is generated. The digital processing of each pixel of each captured image consists in, at least, retaining or discarding said pixel, and when the pixel is retained, in assigning it with one or several positions on the final panoramic or stereoscopic image, with a pre-defined weighted factor for each position on the final panoramic or stereoscopic image.

### TECHNICAL DOMAIN

This invention concerns a process and device for capturing and rendering a stereoscopic or panoramic image stream. This stream of panoramic or stereoscopic images may be stored, forwarded or distributed as a film, or for processing in view of extracting one or several static images from the stream of panoramic or stereoscopic images.

### PRIOR ART

In the domain of “one shot” panoramic image capture, several image capturing devices are known, for example of the camera type CCD or CMOS, with each image capturing device comprising an image sensor, for example of the type CCD or CMOS, coupled with optical means (lens) enabling to project the image of a scene onto the image sensor. The optical axes of the image capturing devices are oriented in different directions, and the optical viewing field of the image capture may overlap in view of covering the complete panoramic field of the image. International patent application WO 2012/032236 discloses an optical device that is particularly compact, comprising three image capturing devices, designated “optical groups” and enabling the “one shot” capture of panoramic images in a 360° field.

In the present document, the term “panoramic image” should be understood in its broadest sense, unlimited to the capture of a single image in a 360° field, but rather more generally applicable to the image rendered according to an extended field, greater than the optical field covered by each of the image capturing devices used for the panoramic image capture.

Using this process of capturing panoramic images, each of the image capturing devices acquires the image of a scene, in the form of a pixel matrix, in a limited optical field, and the images are then forwarded to external means of digital processing which enable the digital “stitching” of the images, at the level of their overlapping areas, in view of producing a final panoramic image.

Each pixel matrix representing an image captured by an image capturing device arises from the two dimensional projection of the 3D surface of a sphere area “viewed' by the image capturing device. This two dimensional projection depends on each image capturing device, and in particular on the optical features of the image capturing lens, and the spatial orientation (“Yaw”, “Pitch” and “Roll”) of the image capturing device during image capture.

In the prior art, digital stitching of images to form a panoramic image, was for example performed when juxtaposing the images delivered by the image sensors, and by performing digital stitching of the images at the level of the their overlapping areas, in view of obtaining a final panoramic image. In this case, the implementation of digital stitching does not modify the two dimensional projection of pixels, and the pixels of the final panoramic image retain the two dimensional projection of the image sensor from which they are derived.

This digital stitching may be performed automatically, such as it is disclosed for example in the international patent application WO 2011/037964, or in the American patent application 2009/0058988; or it may be performed semi-automatically with manual assistance, such as it is disclosed in the international patent application W02010/01476.

Digital image stitching solutions for rendering a panoramic image were also proposed in an article entitled: “Image Alignment and Stitching: A Tutorial”, by Richard Szeliski, dated Jan. 26, 2005. In this article, the digital stitching was performed statically on stored images, rather than dynamically, so that the digital stitching solutions disclosed in this article do not enable to render a dynamic stream of panoramic images, and a fortiori do not enable the rendering of a dynamic stream of panoramic images in real time as the images are being captured.

In the domain of stereoscopic image capture, the process consisting of capturing two flat images of a scene, followed by digital processing of the two flat images, in view of producing a stereoscopic 3D image that enables the perception of depth and contour, is otherwise known.

The above mentioned processes for capturing and rendering panoramic or stereoscopic images present the disadvantage of rendering a panoramic or stereoscopic image using images acquired by sensors which have separate or independent optical means, which generates problems of homogeneity within the final digital image (whether panoramic or stereoscopic), and in particular relative to colorimetry, white balance, exposure time and automatic gain.

Additionally, the above mentioned digital stitching processes of the images require computation time which is detrimental to capturing and rendering of panoramic images in real time as a film.

In the US patent application 2009/0058988, in view of improving processing time and enabling the capture of panoramic images with digital stitching in real time, a digital stitching solution based on the mapping of low resolution images, is for example proposed.

### PURPOSE OF THE INVENTION

In general, the purpose of the present invention is to propose a new technical solution for capturing and rendering a stream of panoramic or stereoscopic images, using one or several image capturing devices.

More particularly, according to a first more specific aspect of the invention, the new solution enables to increase the speed of digital processing, and thus facilitates real time capturing and rendering of a stream of panoramic or stereoscopic images.

More particularly, according to another more specific aspect of the invention, the new solution enables to remedy the above mentioned inconvenience arising from the implementation of sensors with separate or independent optical means, and in particular enables to more easily obtain better quality panoramic or stereoscopic images.

Within the framework of the invention, the stream of panoramic or stereoscopic images may for example be stored, forwarded or distributed as a film, or may be processed later in view of extracting, from the stream, one or several panoramic or stereoscopic images statically.

### SUMMARY OF THE INVENTION

According to a first aspect of the invention, the primary purpose of the invention is a process for capturing and rendering a stream of panoramic or stereoscopic images of a scene, during which, using at least one image capturing device (Cᵢ), several successive capture operations are performed of at least two different images of the scene, in pixel format, with or without overlap of the images, the successive capture operations occurring at a frequency rate (F), defining a capture time (T) between the beginning of two successive capture operations; and for each capture operation, (a) the pixels of each image are digitally processed in view of forming a final panoramic or stereoscopic image using said pixels, with a processing time that is equal to or less than said capture time (T), and (b), a final, previously formed, panoramic or stereoscopic image is generated in an interval of time that is less than or equal to said capture time (T); the digital processing time (a) of each pixel of each captured image consisting in, at least, retaining or discarding said pixel, and when the pixel is retained, assigning it with one or several positions within the final panoramic or stereoscopic image, using a predefined weighted factor (W) for each position on the final panoramic or stereoscopic image.

The other purpose of the invention is a device for capturing and rendering a stream or panoramic or stereoscopic images. This device comprises one or several image capturing devices (Cᵢ), which enable capture of at least two different images as a set of pixels, and electronic means for processing, which enable the rendering of a panoramic or stereoscopic image, using the captured images; the electronic processing means enabling to perform, using the one or several image device(s), several successive capture operations, of at least two different images of a scene, in pixel format, with or without overlap of the images, and with a frequency rate (F) of the successive capture operations, defining a capture time (T) between the beginning of two successive capture operations; the electronic processing means being suited for each capture operation (a) to digitally process the pixels of each captured image in view of forming a final panoramic or stereoscopic image using said pixels with a processing time that is less than or equal to said capture time (T), and (b) to generate, over an interval of time that is less than or equal to the said capture time (T), a final previously formed panoramic or stereoscopic image; the digital processing of each pixel of each image using electronic processing means consisting in, at least, retaining or discarding said pixel, and when the pixel is retained, assigning it with one or several different positions on the final panoramic or stereoscopic image, using a predefined weighted factor (W) for each position on the final panoramic or stereoscopic image.

According to a second aspect of the invention, the purpose of the invention is also a process for capturing and rendering a stream of panoramic or stereoscopic images of a scene, characterized in that using at least one image capturing device (Cᵢ), several successive capture operations are performed of at least two different images of the scene, in pixel format, with or without overlap of the images, and in that during the image capturing operations, the pixels of the captured images are processed digitally, in view of forming panoramic or stereoscopic images, and a stream of panoramic or stereoscopic images is generated, and in that the digital processing of each pixel of each captured image consists in, at least, retaining or discarding, said pixel, and when the pixel is retained, assigning it one of several positions on the final panoramic or stereoscopic image using a predefined weighted factor (W) for each position on the final panoramic or stereoscopic images.

According to said second aspect of the invention, the purpose of the invention is also a device for capturing and rendering a stream of panoramic or stereoscopic images, characterized in that said device comprises one or several image capturing devices (Cᵢ), enabling the capture of at least two different images in pixel set format, and electronic processing means which enable the one or several means of image capture to perform several successive capture operations of at least two different images of a scene, in pixel format, with or without overlap of the images, and which are suited, during the image capture operations, for digital processing of the captured images' pixels, in view of forming panoramic or stereoscopic images, and generating a stream of panoramic or stereoscopic images, and in that the digital processing of each pixel of each captured image consists in, at least, retaining or discarding, said pixel, and when the pixel is retained, assigning it one or several positions on the final panoramic or stereoscopic image with a weighted factor (W) for each position on the final panoramic or stereoscopic image.

According to a third aspect of the invention, the purpose of the invention is also a process for capturing and rendering a stream of panoramic or stereoscopic images of a scene, during which, using at least one image capturing device, several successive capture operations are performed of at least two different images of the scene, in the pixel format, with or without image overlap, each image capturing device enabling to capture an image in pixel set format, and delivering as output for each captured image a stream of pixels, synchronized at least according to a first clock signal (H_sensor). Each pixel of each captured image is processed digitally, in view of generating a final panoramic or stereoscopic image using said pixels as a stream of pixels, synchronized according to, at least, a second clock signal (H).

According to said third aspect of the invention, the purpose of the invention is also a device for capturing and rendering a stream of panoramic or stereoscopic images, said device comprising one or several image capturing devices enabling to perform several successive capture operations of at least two different images of a scene, in pixel format, with or without overlap of the images, and electronic processing means enabling to render a stream of panoramic or stereoscopic images using the captured images. Each image capturing device is suited to deliver, as output for each of the captured images, a stream of pixels synchronized according to, at least, a first clock signal (H_sensor). The electronic processing means are designed to digitally process each pixel of the captured images, in view of generating a final panoramic or stereoscopic image, using said pixels as a stream of pixels, synchronized according to, at least, a second clock signal (H).

According to a fourth aspect of the invention, the purpose of the invention is also to capture and render at least one panoramic or stereoscopic image of a scene, during which at least two different images of the scene are captured, using at least one image capturing device (Cᵢ), with or without image overlap, each image capturing device enabling to capture an image in pixel set format, and delivering as output for each captured image a stream of pixels; the stream of pixels of each captured image being processed digitally in view of rendering at least a final panoramic or stereoscopic image using said pixels, and the digital processing of each pixel of the stream of pixels corresponding to each captured image consisting in, at least, retaining or discarding said pixel, and when the pixel is retained, assigning it with one or several positions on the final panoramic or stereoscopic image, using a predefined weighted factor (W) for each position on the final panoramic or stereoscopic image.

According to said fourth aspect of the invention, the purpose of the invention is also a device for capturing and rendering at least one panoramic or stereoscopic image, said device comprising one or several image capturing devices (Cᵢ), enabling to capture at least two different images, with or without image overlap, each image sensor (Cᵢ) being suited to deliver a stream of pixels for each captured image, and electronic processing means enabling to render, during the image capture operations, a panoramic or stereoscopic image using the pixel streams of each captured image. The digital electronic means are designed to process each pixel of the captured image pixel stream, retaining or discarding said pixel, and when the pixel is retained, assigning it with one or several different positions on the final panoramic or stereoscopic image, with a weighted factor (W) for each position on the final panoramic or stereoscopic image.

### BRIEF DESCRIPTION OF THE FIGURES

The characteristics and advantages of the invention will become clearer in light of the following detailed description of one of the preferred embodiments of the invention, with said description provided as a non-limiting or exhaustive example of the invention, and in reference to the appended drawings, among which:

FIG. 1 is the synopsis of an example of the electronic architecture of a device according to the invention.

FIG. 2 is a chronograph example of the main electronic signals of the device in FIG. 1.

FIG. 3 represents an example of correspondence between the optical/pixel field of the capture area of a “fisheye” lens.

FIG. 4 is an example of the remapping of a pixel matrix captured, using an image sensor in a portion of a final panoramic image.

FIG. 5 illustrates an example of geometric correspondence between a pixel P_{i,j} of the final panoramic image, and the captured pixel matrix using an image sensor.

FIGS. 6A to 6I represent different remapping Figures, for the particular case of a RAW type image.

FIGS. 7A to 7D illustrate different examples of the remapping of a sensor line onto a panoramic image.

FIG. 8 illustrates a particular example of the remapping results for three images in view of forming a final panoramic image.

### DETAILED DESCRIPTION

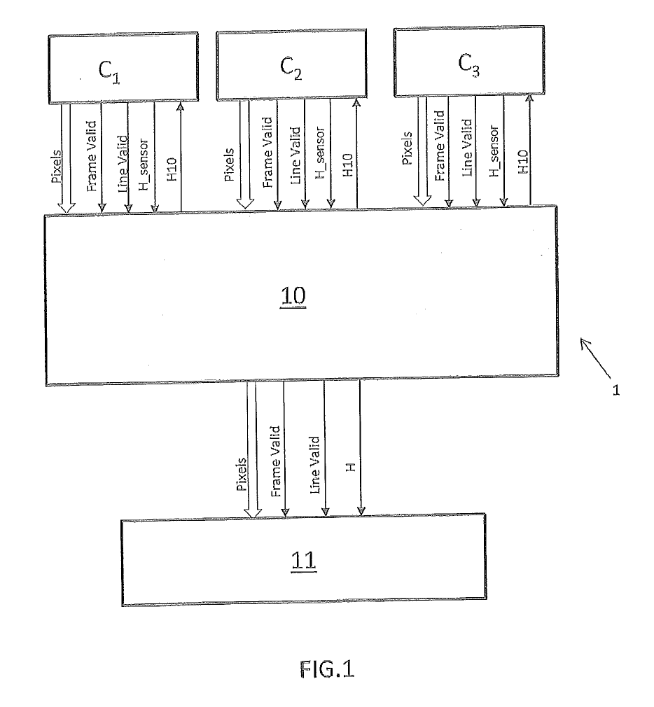

FIG. 1 represents a particular example of the invention device 1, enabling to capture and render panoramic images.

In this particular example, device 1 comprises three image capturing devices C₁, C₂, C₃, for example of the type CCD or CMOS, which each allowing for the capture of an image, in a pixel matrix format, and electronic processing means 10 enabling to render a panoramic image using the pixels delivered by the image sensors C₁, C₂, C₃. Usually, each of the image capturing devices C₁, C₂, C₃, comprise an image sensor, for example of the type CCD or CMOS, coupled to optical means (a lens) comprising one or several lenses aligned with the image sensor, and enabling to focus the lights rays onto the image sensor.

The optical axes of the image capturing devices C₁, C₂, C₃ are oriented in different directions, and their optical fields cover the entire final panoramic image field, preferably with overlap of the optical fields.

In the present document, the term “panoramic image” is to be understood in its broadest sense, unlimited to a panoramic image rendered according to a 360° field, but rather more generally as an image rendered according to an extended field, greater than the optical field covered by each of the image capturing devices used for the panoramic image capture.

For exemplification purposes only, said image capturing devices C₁, C₂, C₃, may for example consist of the three optical groups of the compact optical device, which is disclosed in the international patent application WO 2012/03223, and which enables the “one shot” capture of panoramic images.

Preferably, but not necessarily, the invention device 1 consists of portable equipment, for the purposes of being easily transported and used in various locations.

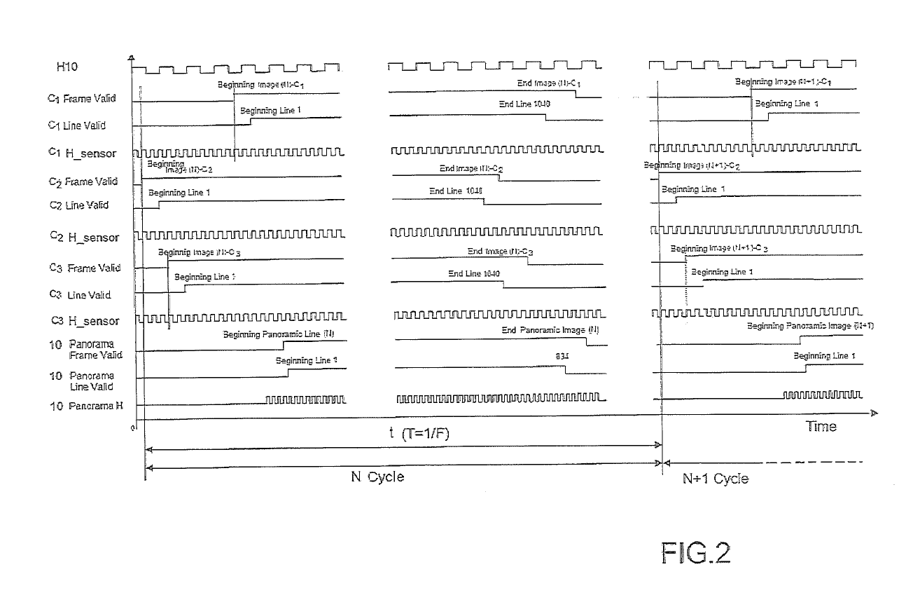

In reference to FIG. 2, the digital processing means 10, deliver a basic clock H10, which is generated for example using a quartz, and which is used to time the operation of the image sensor of each of the image capturing devices C₁, C₂, C₃.

As output, the image sensor of each of the image capturing devices C₁, C₂, C₃, delivers for each image captured, a stream of pixels on a “Pixels” data bus, synchronized according a first clock signal (H_sensor), which is generated by each of the image capturing sensors using the basic clock H10, and two signals “Line Valid” and “Frame Valid”. The clock signals (H_sensor), which are generated by each of the image capturing devices C₁, C₂, C₃, are more particularly of the same frequency.

The electronic processing means 10 enable to render a panoramic image using the pixels delivered by the image sensors of the image capturing devices C₁, C₂, C₃, and in a manner comparable to that of the image capturing devices C₁, C₂, C₃, deliver, as output on a “Pixels” data bus, a stream of pixels representing the final panoramic image.

The size of the “Pixels” data bus of the electronic processing means 10 may be identical or different from that of the “Pixels” data buses of the image capturing devices C₁, C₂, C₃, and is preferably greater. For example, but in a way that does not limit the scope of the invention, the “Pixels” data buses of the image capturing devices C₁, C₂, C₃ are eight bits, and the “Pixels” data bus of the electronic processing means 10 are 16 bits.

The stream of pixels generated by the electronic processing means 10, is synchronized according to a second clock signal (H), which is generated by the electronic processing means 10, using the basic clock signal and the two “Line Valid” and “Frame Valid” signals, which are generated by the electronic processing means 10.

FIG. 2 illustrates a particular, and non-limiting, example of the signal synchronization of the invention, mentioned above. On this Figure the data that is transiting on the “Pixels” data buses is not represented.

In reference to FIG. 2, the successive capture operations are cyclical, and are timed at a frequency F, which defines a capture time T (T=1/F), equal to the length of the timed interval (t), between the beginning of two successive capture operations.

More particularly, on said FIG. 2, the rising edge of the signal “Frame Valid”, of each of the image capturing devices C₁, C₂, C₃, synchronizes the beginning of the transmission, on the “Pixels” data bus of each of the image capturing devices C₁, C₂, C₃, of the pixels of an image captured by the image capturing devices C₁, C₂, C₃. The descending edge of the signal “Frame Valid”, of each of the image capturing devices C₁, C₂, C₃, indicates the end of the pixel transmission, on the “Pixels” data bus, of an image captured by said image capturing devices C₁, C₂, C₃. Said rising edges (and respectively descending) of the “Frame Valid” signals, delivered by the image capturing devices C₁, C₂, C₃, are slightly offset on a timeline.

The “Line Valid” signal of the image capturing device C₁, C₂, C₃ is synchronized with each rising edge of the “Frame Valid” signal, and indicates the beginning of the transmission of a line of image pixels. Each descending edge of the “Line Valid” signal indicates the end of transmission of a line of image pixels. The pixels of each transmitted image on each “Pixels” data bus of the three image capturing devices C₁, C₂, C₃ are sampled in parallel, using the electronic processing means 10, respectively using each clock signal “H_sensor” delivered by each of the image capturing devices C₁, C₂, C₃.

In reference to FIG. 2, the rising edge of the “Frame Valid” signal, delivered by the electronic processing means 10, synchronizes the beginning of the transmission on the “Pixels” data bus of the electronic processing means, of a final panoramic image rendered using the pixels delivered by the image capturing devices C₁, C₂, C₃. Said rising edge is generated automatically, by the electronic processing means 10, using the rising edges of the “Frame Valid” signals, delivered by the image capturing devices C₁, C₂, C₃, and more particularly generated upon detection of the last generated rising edge, that is, in the particular example of FIG. 2, of the rising edge of the “Frame Valid” signal delivered by the image capturing device C₁.

The descending edge of the “Frame Valid” signal, delivered by the electronic processing means 10, synchronizes the end of transmission on the “Pixels” data bus of the electronic processing means 10, of a final panoramic image, rendered using the pixels delivered by the image capturing devices C₁, C₂, C₃.

The “Line Valid” signal, delivered by the electronic processing means 10, is synchronized with each rising edge of the ‘Frame Valid” signal, delivered by the electronic processing means 10, and indicates the start of transmission of a line of pixels of the panoramic image. Each descending edge of the “Line Valid” signal, delivered by the electronic processing means 10, indicates the end of transmission of a line of pixels of the panoramic image.

Writing of the pixels of each panoramic image on the “Pixels” data bus of the electronic processing means 10, is synchronized according to the clock signal “H”, which is generated by the electronic processing means 10, and which may be used by another external electronic device (for example device 11) to read pixels on said data bus.

According to an alternative embodiment of the invention, the clock signal “H”, delivered by the electronic processing means 10, may be synchronous or asynchronous with the “H_sensor” clock signals delivered by the image capturing devices C₁, C₂, C₃. The frequency of the “H” clock signal may be equal to or different from the “H_sensor” clock signals delivered by the image capturing devices C₁, C₂, C₃. Preferably, the frequency of the “H” clock signal is greater than the frequency of the “H_sensor” signal, delivered by the image capturing sensors C₁, C₂, C₃, as illustrated in FIG. 2.

In the particular case of FIG. 2, for each capture operation, three image captures are performed in parallel using the image capturing devices C₁, C₂, C₃ and in this particular case, the interval of time (t) is the interval of time separating two successive rising edges of the “Frame Valid” signal of the image capturing device C₁, that is, of the image capturing device that first transmits pixels on its “Pixels” data bus.

During said interval of time (t) separating the beginning of the two successive image capture operations, the electronic processing means 10:
(a) digitally process the pixels of each captured image, in view of rendering a final panoramic image using said pixels; for the architecture of FIG. 1 and the signals of FIG. 2, these are the pixels transmitted to the electronic processing means 10, on the “Pixels” data bus of the image capturing devices C₁, C₂, C₃, and
(b) generate a final panoramic image; for the architecture of FIG. 1 and the signals of FIG. 2, these are pixels delivered as output by the electronic processing means 10, on their “Pixels” data buses, with the rising and descending edges of the “Frame Valid” signal, delivered by the electronic processing means, generated during said interval of time (t).

Thus, the stream of successive panoramic images is generated in real time by electronic processing means at the same rate as the successive operations of image capture. For example, if the image capturing devices C₁, C₂, C₃ are designed to deliver 25 images per second, the capture time T of each time interval (t) between two successive image capturing operations is equal to 40 ms, which corresponds to a capture frequency F of 25 Hz, and the electronic processing means also generate 25 panoramic images per second (one panoramic image every 40 ms).

Capture time T (the length of each time interval (t) between two successive image capture operations) will depend on the technology of the image capturing devices C₁, C₂, C₃. In practice, capture time T will preferably be less than or equal to 1 s, and even more preferably less than or equal to 100 ms.

Preferably, the final panoramic image that is generated during each time interval (t), which separates the beginning of two successive image capturing operations, arises from digital processing (a) of the pixels during the course of this same time interval (t). In this case, each successive panoramic image is generated in real time, and almost at the same time as the image capture that was used to render the particular panoramic image, and prior to the subsequent image capturing operations that will be used to render the subsequent panoramic image.

In another alternative embodiment, the final image generated during each time interval (t), which separates the beginning of two successive image capturing operations, arises from the digital processing (a) of the pixels, occurring during a previous time interval (t), and for example the preceding time interval (t). In this case, each successive panoramic image is generated in real time, and with a slight timed offset relative to the image capture which was used to render the panoramic image.

In another alternative embodiment, the generation of each panoramic image may start (rising edge of the “Frame Valid” signal delivered by the electronic processing means 10) during a given capture cycle (N), and may finish (descending edge of the “Frame Valid” signal delivered by the electronic processing means 10) during the following capture cycle (N+1). Preferably, but not necessarily, the interval of time between the rising edge and descending edge of the ‘Frame Valid” signal, delivered by the electronic processing means 10, is less than or equal to capture time T.

Processing (a) of the pixels performed for each image capture operation may be offset on a time line, relative to the image capturing cycle. Preferably, but not necessarily, the processing time for pixels from all of the captured images, during an image capturing operation, to be used for the rendering of the final panoramic image, is less than or equal to capture time T. For example, processing (a) of the pixels, in view of forming a final panoramic image, using the images captured during the N capture cycle, may be performed by the electronic processing means 10, during a subsequent image capturing cycle, for example during the N+1 image capturing cycle.

The electronic processing means 10 comprise an electronic, digitally programmed data processing unit, which may, indiscriminately according to the invention, be implemented using any known means of electronic circuitry, such as for example, one or several programmable circuits of the FPGA type, and/or one or several specific circuits of the type ASIC, or a programmable processing unit, the electronic architecture of which embodies a micro-controller or a microprocessor.

In the particular variation of the invention illustrated in FIG. 1, the stream of successive panoramic images, delivered as a set of pixels by the electronic processing means 10, is processed by additional electronic processing means 11, which comprise, for example, a DPS-type circuit, and which enable, for example, to store in a memory, and/or to display in real time, on a screen, the stream of panoramic images in film format.

In another variation of the invention, the additional electronic processing means 11 may be designed to process the stream of successive panoramic images, delivered by the electronic processing means 10, as extracting means of one or several panoramic images from the stream.

Usually, in a particular alternative embodiment, each image capturing device C₁, C₂, C₃ comprises optical means of the type “fisheye” lens, connected to a capture matrix, and each captured image is characterized by three sets of spatial orientation information, which are commonly referred to as “Yaw”, “Pitch” and “Roll”, and which are specific to the spatial orientation of said image capturing device during image capture.

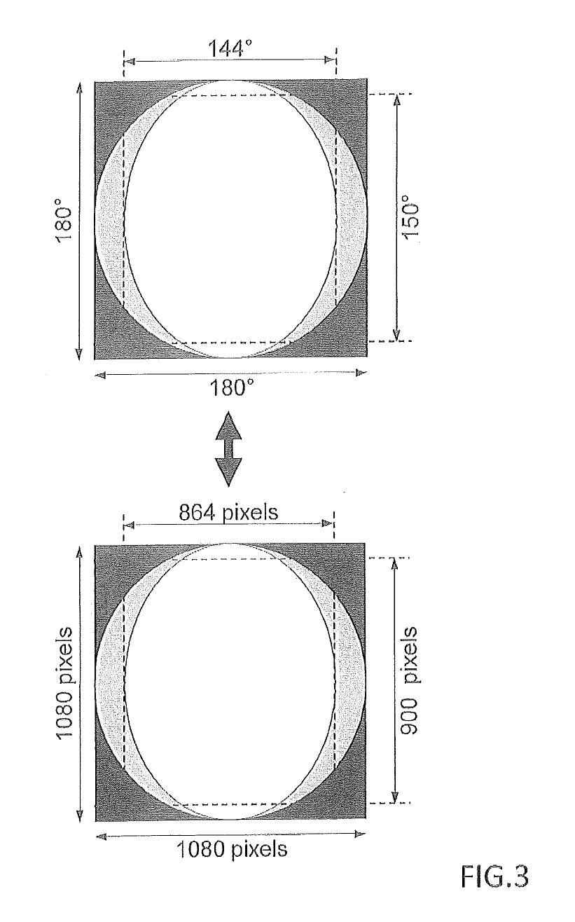

In reference to FIG. 3, a “fisheye” lens presents an effective spherical central detection surface (grayed surfaces and white surface on FIG. 3), and the effective pixels of the image captured by the image sensor are known to result from a two-dimensional projection of only a part (FIG. 3-864 pixels by 900 pixels) of the detection surface of the image capturing device.

Thus, usually, each pixel matrix representing a captured image by an image capturing device C₁, C₂, or C₃ arises from a two dimensional projection of a spherical 3D surface part, “seen” by the image capturing device C₁, C₂, or C₃. This two dimensional projection depends on each image capturing device C₁, C₂, or C₃, and in particular, on the optical means of the image capturing device C₁, C₂, or C₃, and on the spatial orientation (“Yaw”, “Pitch” and “Roll”) of the image capturing device C₁, C₂, or C₃ during image capturing.

For exemplification purposes, we represented in FIG. 4, a pixel matrix corresponding to an image captured by an image capturing device Cᵢ (for example an image capturing device C₁, C₂ or C₃ of FIG. 1). On said Figure, the black pixels correspond to the pixels located outside of the effective central circular part of the “fisheye” lens of the image capturing device Cᵢ. Each pixel of said captured images, using the image capturing device Cᵢ, arises from an operation termed “mapping”, which corresponds to the above mentioned two dimensional projection of the spherical 3D surface part “seen” by the “fisheye” lens of the image capturing device Cᵢ, and which is specific to the image capturing sensor Cᵢ.

Prior to the invention, in order to render a panoramic image, using images captured by each image capturing device Cᵢ, said images were most often juxtaposed via digital “stitching” of the images, at the level of their overlapping areas, in view of obtaining a final continuous panoramic image. It is important to understand that this type of digital stitching, invoked in the prior art, does not modify the two dimensional projection of pixels, which are retained on the final panoramic image.

In the invention herein, in contrast to the above mentioned digital stitching of the prior art, to render the final panoramic image, the effective pixels of each image captured by each sensor Cᵢ, are remapped on the final panoramic image, with at least one part of said pixels that is remapped on the final panoramic image, preferably when submitted to a new two dimensional projection, which is different from the two dimensional projection on the image of the image capturing device Cᵢ, and from which said pixels are derived. Thus, a single virtual panoramic image capturing device is being rendered, using the image capturing devices C₁, C₂, or C₃. This remapping of pixels is performed automatically, via processing (a) of each pixel of each captured image, which consists in, at least, retaining or discarding said pixel, and when the pixel is retained, assigning it one or several positions on the final panoramic image, with a weighted factor for each position on the final panoramic image.

In FIG. 4, only a portion of the final panoramic image is represented, said portion corresponding to the part of the panoramic image, arising from remapping of the pixels of a captured image by a single image capturing device Cᵢ.

In reference to said FIG. 4, the pixel P_{1,8} located on the first line of the image captured by the image capturing device Cᵢ, is for example remapped on the final panoramic image as four pixels P_{1,9}, P_{1,10}, P_{1,11}, P_{1,12}, in four different adjacent positions on the first line of the final panoramic image, which translates as a pulling apart of this pixel from the original image to the final panoramic image. The mapping of this pixel P_{1,8} on the final panoramic image thus correspond to a two dimensional projection of this pixel on the final panoramic image, which is different from the two dimensional projection of this pixel on the original image captured by the image processing device. This pulling apart of the pixel on the final panoramic image may for example be advantageously embodied to compensate, in part or in whole, for the optical distortion of the “fisheye” lens of the image capturing device near the upper edge. The same pulling apart of pixels may be advantageously embodied for those pixels located at the lower edge.

For comparison purposes, the central pixel P_{8,8} of the image captured by the image capturing device Cᵢ is remapped identically on the final panoramic image as a unique pixel P_{11,11}, since the “fisheye” lens of the image capturing device does not, or almost does not, invoke any optical distortion at the center of the lens.

Pixel P_{10,3}, located on a lower left area of the image captured by the sensor Cᵢ is for example remapped on the final panoramic image as three pixels P_{17,4}, P_{18,4}, P_{18,5}, in three adjacent and different positions on two adjacent lines of the final panoramic image, which translates as enlargement in two directions for this pixel P_{10,3} of the original image into final panoramic image. Mapping of this pixel P_{10,3} on the final panoramic image thus correspond to a two dimensional projection of this pixel on the final panoramic image, which is different from the two dimensional projection of this pixel on the original image captured by the image capturing device.

During this remapping operation of each pixel of the original image, from the image capturing sensor Cᵢ, onto the final panoramic image, it is possible that a pixel is not retained, or recovered, on the final panoramic image. This occurs, for example, with pixels located in an overlapping area of the images captured by at least two image capturing devices. In an overlapping area of the image capturing devices, only a single pixel will be retained from one of the sensors, the other pixels corresponding to the other sensors will not be retained. In another variation of the invention, in the overlapping area of at least two image capturing devices, it is possible to render the final image pixel using an average, or a combination, of the original image pixels.

During the remapping operation of a pixel, when the pixel is retained, and has been assigned one or several different positions on the final panoramic image, said assignment is preferably performed using a weighted factor, ranging from 0 to 100%, for each position on the final panoramic image, that is, for each pixel of the final panoramic image. Said weight factoring process, and the reasons underlying it, will be better understood in light of FIG. 5.

In reference to FIG. 5, the center C of each of the pixels P_{i,j} of the final panoramic image does not correspond in practice to the center of a pixel of the image captured by an image capturing device Cᵢ, rather it corresponds geometrically to a particular real position P on the image captured by an image capturing device Cᵢ, which in this particular example, represented in FIG. 4, is de-centered, within proximity of the lower corner, and to the left of pixel P₁ of the image captured by the image capturing device Cᵢ. Thus, the pixel P_{i,j}, in this particular example, will be rendered not only using pixel P₂, but also the neighboring pixels P₁, P₃, P₄, with weight factoring for each pixel P₁, P₂, P₃, P₄, for example taking into consideration the barycenter of position P relative to the center of each pixel P₁, P₁, P₂, P₃, P₄. In this particular example, the pixel P_{i,j} consists for example of 25% pixel P¹, 35% pixel P₂, 15% pixel P₃ and 5% pixel P₄.

The invention applies to all types of image formats: RAW, YUV and RGB derivatives. For the case of RGB images, where color rendering was already performed (known as R, G. B information for each image pixel), the above mentioned weight factoring will be implemented using the adjacent pixels.

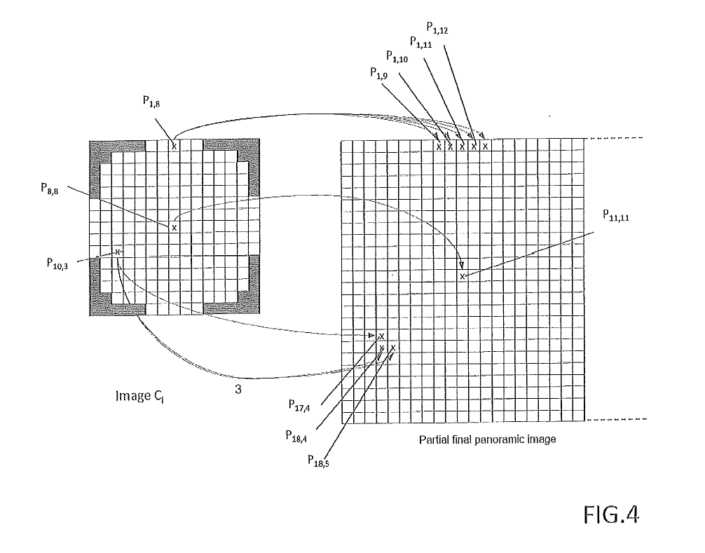

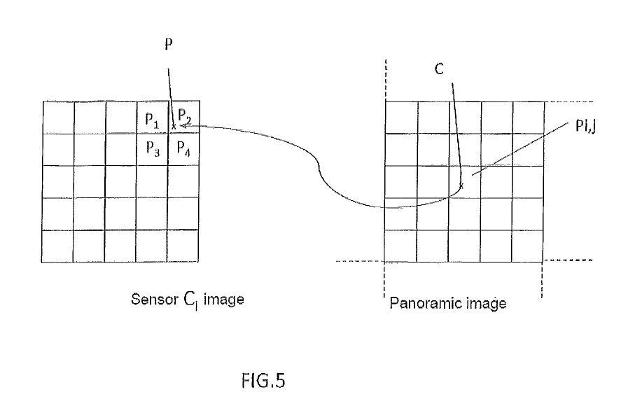

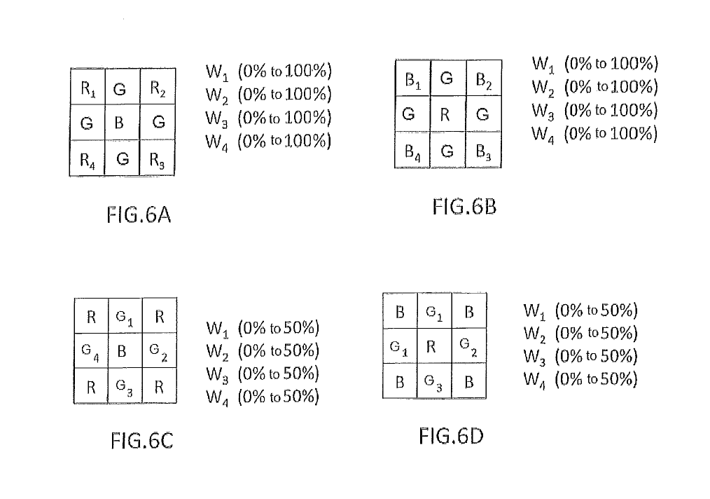

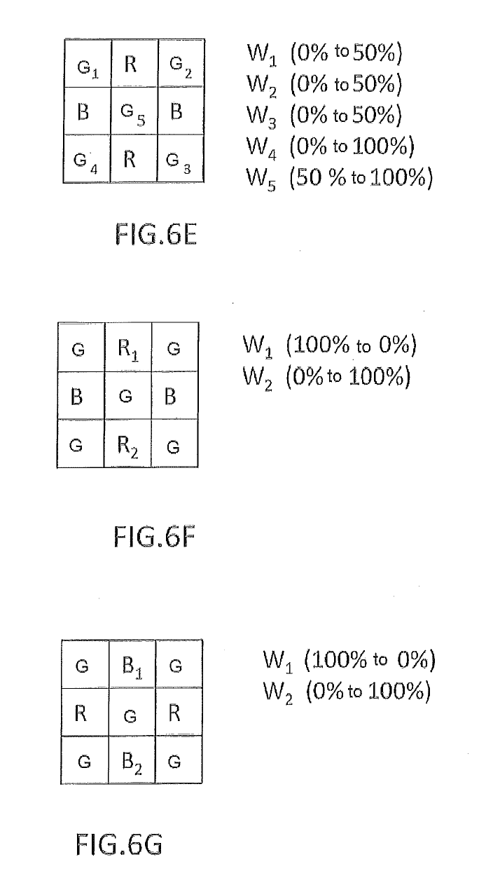

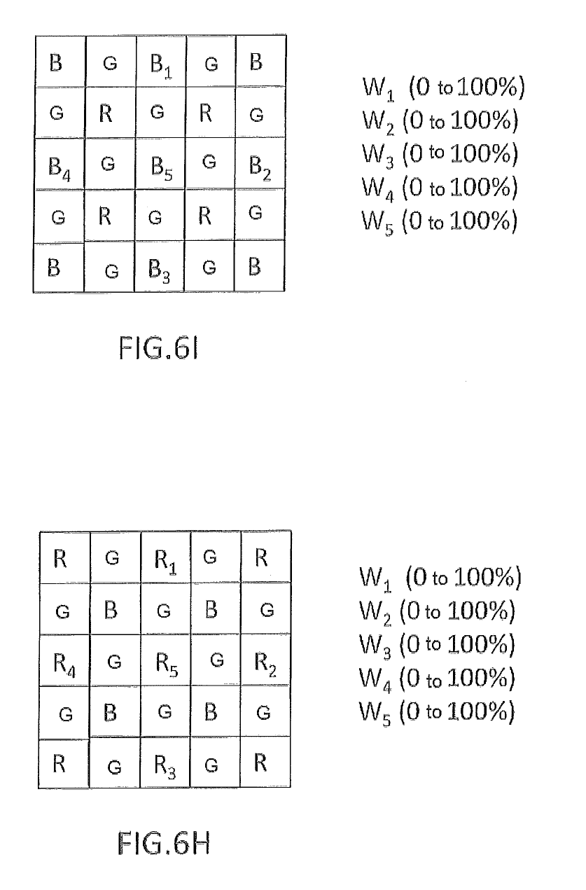

However, for the case of RAW images, in which each pixel only represents one colorimetric component, the above mentioned weight factoring will be implemented using the proximal pixels of the same color as the pixel of the final panoramic image. This particular case of weight factoring for RAW format will be better understood in light of FIGS. 6A to 6I.

FIGS. 6A to 6I represent the various cases of correspondence between a pixel P_{i,j} of the final panoramic image and a pixel matrix of the image captured by an image capturing device Cᵢ for the case of pixels coded in RAW-type format. On said figures, the letters R, G, B respectively correspond to a Red, Green, and Blue pixel. Wᵢ is the weight factor on the final image of pixels Rᵢ, Gᵢ or Bᵢ of the original image captured by the image capturing device.

FIG. 6A corresponds to the case where the center of a red pixel P_{i,j} of the final panoramic image corresponds to a real position P in the image captured by the image capturing device Cᵢ, which is on a blue pixel (B) of the image captured by the image capturing device Cᵢ. In this case, said red pixel P_{i,j} of the final panoramic image will be rendered using the red pixels R₁, R₂, R₃, R₄ proximal to said blue pixel B, by respectively applying the weighted factors W₁, W₂, W₃, W₄. The values of these weighted factors W₁, W₂, W₃, W₄ for example will depend upon the barycenter of positions P relative to the center of each pixel R₁, R₂, R₃, R₄. For example, if the position P is located at the center of pixel P, in this case all the weighted factors W₁, W₂, W₃, W₄ will be equal to 25%.

FIG. 6B corresponds to the case where the center of a blue pixel P_{i,j} of the final panoramic image corresponds to a real position P in the image captured by a sensor Cᵢ which is on the red pixel (R) of the image captured by an image capturing device Cᵢ.

FIG. 6C corresponds to the case where the center of a green pixel P_{i,j} of the final panoramic image corresponds to a real position P of the image captured by a sensor Cᵢ, which is on a blue pixel (B) of the image captured by an image capturing device Cᵢ.

FIG. 6D corresponds to the case where the center of a green pixel P_{i,j} of the final panoramic image corresponds to a real position P in the image captured by a sensor Cᵢ which is on a red pixel (R) of the image captured by an image capturing device Cᵢ.

FIG. 6E corresponds to the case where the center of a green pixel P_{i,j} of the final panoramic image corresponds to a real position P of the image captured by a sensor Cᵢ which is on a green pixel (G₅) of the image captured by an image capturing device Cᵢ.

FIG. 6F corresponds to the case where the center of a red pixel P_{i,j} of the final panoramic image corresponds to a real position P of the image captured by a sensor Cᵢ, which is on a green pixel (G) of the image captured by an image capturing device Cᵢ.

FIG. 6G corresponds to the case where the center of a blue pixel of the final panoramic image corresponds to a real position P of the image captured by a sensor Cᵢ which is on a green pixel (G) of the image captured by an image capturing device Cᵢ.

FIG. 6H corresponds to the case where the center of a red pixel P_{i,j} of the final panoramic image corresponds to a real position P of the image captured by an image capturing device Cᵢ which is on a red pixel (R₅) of the image captured by an image capturing device Cᵢ.

FIG. 6I corresponds to the case where the center of a blue pixel P_{i,j} of the final panoramic image corresponds to a real position P of the image captured by a sensor Cᵢ, which is on a blue pixel (B₅) of the image captured by an image capturing device Cᵢ.

Finally, regardless of the coding format of an image, the remapping process, on the final panoramic image of each pixel of the image captured by an image capturing device Cᵢ, consists in, at least, retaining or discarding said pixel, and when the pixel is retained to assign it with one or several different positions on the final panoramic or stereoscopic image with a predefined weighted factor for each position (that is, for each pixel) of the final panoramic image. In the present document, the notion of “position” on the final panoramic image merges with the notion of “pixel” on the final panoramic image.

According to the invention, when wise remapping of pixels occurs, it is possible for example to correct at least partially those distortions on the final image of each lens of each image capturing device Cᵢ.

Also according to the invention, the image capturing devices C₁, C₂, C₃ and the electronic processing means 10, are seen for example by additional electronic processing means 11, as a unique virtual sensor for panoramic images. Consequently, the additional electronic processing means 11, may for example embody known image processing algorithms (in particular algorithms for white balancing, exposure time and gain management) for the final panoramic image delivered by the electronic processing means 10, which enables, whenever applicable, to obtain a final image that is more homogeneous, and in particular in regards colorimetry, white balance, and exposure time and gain, compared to the implementation of these algorithms for the processing of images for each image delivered by the image capturing devices C₁, C₂, C₃, prior to rendering of the panoramic image.

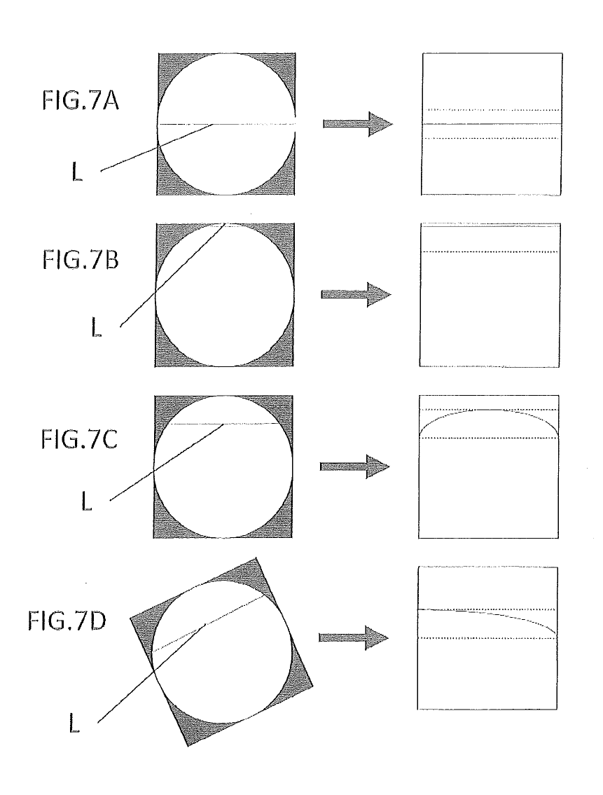

For exemplification purposes only, and without limiting the scope of the invention, we represented in FIGS. 7A to 7D particular examples of pixel remapping from a line L of the original image of a “fisheye” lens, in view of factoring in the optical distortion of the “fisheye” lens and its orientation in space (Yaw, Pitch and Roll). Remapping depends on the position of Line L compared to the center and the lower and upper edges of the “fisheye” lens (FIGS. 7A, 7B, 7C), or depends on the spatial orientation of the “fisheye” lens (FIG. 7D).

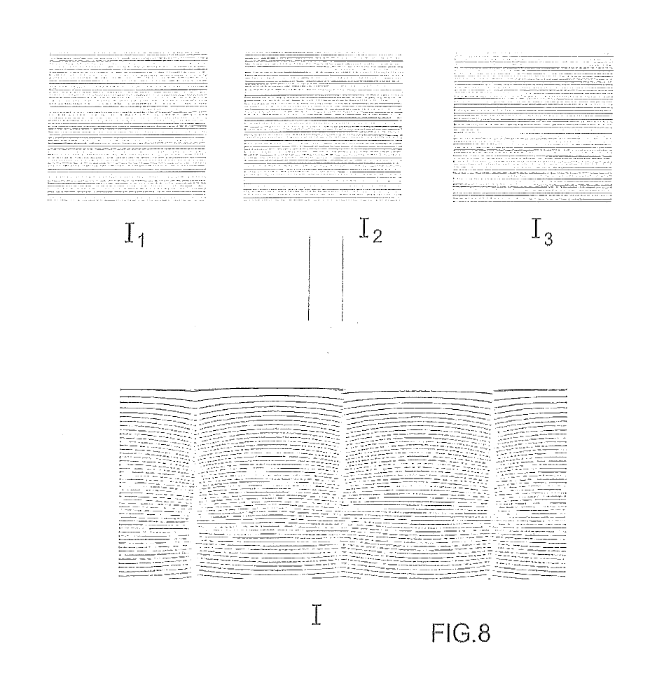

We represented in FIG. 8, a particular example of three images I₁, I₂, I₃, respectively captured by three image sensors C₁, C₂, C₃ and the final panoramic image (I) resulting from remapping of the pixels of images I₁, I₂, I₃.

Within the framework of the invention, it is possible to use pixel remapping to render a final panoramic image via implementation of any type of two dimensional projection that is different from the two dimensional projection of the image capturing devices C₁, C₂, C₃, for example for the purposes of automatically incorporating special effects on the final panoramic image. In particular, the following known projections may be implemented:
planar or rectilinear projection
cylindrical projection
Mercator projection
Spherical or equirectangular projection

In view of enabling remapping operations, those skilled in the art must predefine, on a case by case basis, the remapping of each pixel, of each image capturing device Ci, determining for each pixel of each image capturing device Ci, whether this pixel is retained, and in this case the pixel or those pixels that correspond to the final panoramic image, and the weighted factor of this original pixel for each pixel of the final panoramic image.

This remapping may for example be implemented as a Correspondence Table of the below type, assigning to each pixel P_{X,Y} of each image capturing device Cᵢ that is retained on the final panoramic image, one or several pixels (P_{Xpano},_{Ypano}) on the final panoramic image with a weighted factor W of the pixel P_{X,Y} on the pixel (P_{Xpano}, _{Ypano}) of the final panoramic image. In the Table below, for clarity purposes, we only included for exemplification purposes, those particular pixels exemplified in FIG. 4.

### Sensor Cᵢ

| | | |
|---|---|---|
| Image sensor pixel | Panoramic image pixel | Weight % |

| X | Y | Xpano | Ypano | factor (W) |
|---|---|---|---|---|
| . . . | . . . | . . . | . . . | . . . |
| 1 | 8 | 1 | 9 | 15 |
| 1 | 8 | 1 | 10 | 25 |
| 1 | 8 | 1 | 11 | 35 |
| 1 | 8 | 1 | 12 | 15 |
| . . . | . . . | . . . | . . . | . . . |
| 8 | 8 | 11 | 11 | 100 |
| . . . | . . . | . . . | . . . | |
| 10 | 3 | 17 | 4 | 25 |
| 10 | 3 | 18 | 4 | 15 |
| 10 | 3 | 18 | 5 | 50 |
| . . . | . . . | . . . | . . . | . . . |

For the particular case of the architecture appearing in FIG. 1, the remapping operation, on the final panoramic image of each pixel of each image capturing device C₁, C₂, C₃, is performed automatically using the electronic processing means 10, based on a Correspondence Table, stored in one of the memories. In another variation of the invention, remapping computations on the final panoramic image, of each pixel of each image capturing device C₁, C₂, C₃ may also be performed automatically with the electronic processing means 10, using a calibration and dynamic computation algorithm, stored in the memory.

In the example of FIG. 1, each pixel (P_{Xpano}, _{Ypano}) of the panoramic image resulting from the remapping operation is delivered as output of the electronic processing means 10 (“Pixels”), while synchronized according to the “H” clock signal delivered by the electronic processing means 10. According to an alternative embodiment, the “H” clock signal, delivered by the electronic processing means 10, may be synchronous or asynchronous with the “H_sensor” clock signals, delivered by the image sensors C₁, C₂, C₃.

One advantage of the architecture of FIG. 1 is that it enables the additional electronic processing means 11 to “see” the image sensor C₁, C₂, C₃ and the electronic processing means 10, as a single virtual panoramic sensor.

The device of FIG. 1 may advantageously be used to perform real time remapping of pixels as they are acquired by the electronic processing means 10.

The invention is not limited to the implementation of three fixed image capturing devices C₁, C₂, C₃, rather it may be implemented, more generally, with at least two fixed image capturing devices C₁, C₂.

It is also anticipated within the framework of the invention to use a single mobile image capturing device, with each image capture corresponding to a different orientation and/or position of the mobile image capturing device C₁, C₂, C₃.

In a particular variation of the embodiment that was described, the capture frequency F is equal to the capture frequency of the image capturing devices C₁, C₂, C₃. In another variation, the capture frequency F may be less than the capture frequency of the image capturing devices C₁, C₂, C₃, with the electronic processing means only processing, for example. one image our of m images (m≧2), delivered by each of the sensors, which corresponds to a frequency of the successive capture operations that is less than the frequency of the images delivered by the image capturing devices C₁, C₂, C₃.

The invention is not limited to the rendering of panoramic images. It may also be applied to the rendering of stereoscopic images.

1.-134. (canceled)

135. A process for capturing and forming a stream of panoramic or stereoscopic images of a scene, wherein using at least one image capturing device, several successive capture operations are performed of at least two different images of a scene, in pixel format, with or without overlap of the images, wherein during the image capture operations, the pixels of the captured images are digitally processed so as to form panoramic or stereoscopic images, and a stream of panoramic or stereoscopic images is generated, and wherein the digital processing of each pixel of each captured image consists in, at least, retaining or discarding said pixel, and when the pixel is retained, assigning it with one or several positions on the final panoramic or stereoscopic image, with a pre-defined weighted factor for each position on the final panoramic or stereoscopic image.

136. The process according to claim 135, wherein the successive capture operations are timed at a frequency rate, which defines a capture time between the beginning of two successive capture operations.

137. The process according to claim 136, wherein for each capture operation, the pixels of each captured image are digitally processed so as to form a final panoramic or stereoscopic image using said pixels, with a processing time that is less than or equal to the said capture time, and a final panoramic or stereoscopic image is generated, in an interval of time that is less than or equal to said capture time.

138. The process according to claim 135, wherein the successive capture operations are timed at a frequency rate, which defines an interval of time between the beginning of the two successive capture operations, and the final panoramic or stereoscopic images are generated, in succession, at the same frequency rate as the image capture frequency rate.

139. The process according to claim 135, wherein the successive image capture operations are timed at a frequency rate, which defines a capture time between the beginning of two successive image capturing operations, and the image capture time is less than or equal to 1 s, and preferably less than or equal to 100 ms.

140. The process according to claim 135, wherein each final panoramic or stereoscopic image is generated, in succession, during each interval of time separating the beginning of two successive image capturing operations.

141. The process according to claim 140, wherein the final panoramic or stereoscopic image, generated during an interval of time separating the beginning of two successive capture operations, arises out of the digital processing of pixels, performed during the same interval of time.

142. The process according to claim 140, wherein the final panoramic or stereoscopic image, generated during an interval of time, separating the beginning of two successive capture operations, arises out of the digital processing of pixels, performed during a preceding interval of time.

143. The process according to claim 135, wherein the digital processing of each pixel is performed so that at least one part of the pixels of the captured images is mapped onto the final panoramic or stereoscopic image, after being submitted to a two dimensional projection that is different from the two dimensional projection of said same pixels, onto the image of the image capturing device from which they are derived.

144. The process according to claims 135, wherein several pixels of the captured images are processed, by assigning to each one, several different positions on the final panoramic or stereoscopic image.

145. The process according to claim 135, wherein several pixels of the captured images are processed, by assigning to each one, a position on the final panoramic or stereoscopic image with a weighted factor that is not zero, and strictly less than 100%.

146. The process according to claim 135, wherein at least two different images of the scene are captured, using at least two different image capturing devices.

147. The process according to claim 135, wherein at least three different images are captured, using at least three image capturing devices.

148. A device for capturing and forming a stream of panoramic or stereoscopic images characterized in that the device comprises one or several image capturing devices, enabling capture of at least two different images in pixel set format, and electronic processing means, which enable, using said image capturing device, to perform several successive capture operations of at least two different images of a scene, in pixel format, with or without overlap of the images, and which are suited, during the capture operations, to digitally process the pixels of the captured images, in view of forming panoramic or stereoscopic images, and generating a stream of panoramic or stereoscopic images, and in that the digital processing of each pixel of each captured image consists in, at least, retaining or discarding said pixel, and when the pixel is retained, assigning it with one of several positions on the final panoramic or stereoscopic image with a weighted factor for each position on the final panoramic or stereoscopic image.

149. The process according to claim 148, wherein the electronic processing means enable, using said image capturing device(s) to perform said successive image capturing operations at a frequency rate of the successive capture operations, which defines a capture time between the beginning of two successive capture operations.

150. The device according to claim 149, wherein for each capture operation, the electronic processing means are suited to digitally process the pixels of each captured image, in view of forming a final panoramic or stereoscopic image using said pixels, with a processing time that is less than or equal to the capture time, and to generate, in an interval of time that is less than or equal to said capture time, a final panoramic or stereoscopic image that was previously formed.

151. The device according to claim 148, wherein the electronic processing means enable, using said image capturing device(s), to perform said successive image capturing operations, at a frequency rate of the successive image capturing operations, which defines a capture time between the beginning of two successive image capture operations, and are suited to generate final panoramic or stereoscopic images, at the same frequency rate as the capture frequency.

152. The device according claim 148, wherein the electronic processing means enable, using said image capturing device(s), to perform said successive capture operations at a frequency rate of the successive image capturing operations, which defines a capture time between the beginning of two successive capture operations, and the capture time is less than or equal to 1 s, and preferably less than or equal to 100 ms.

153. The device according to claim 148, wherein the electronic processing means are designed to generate, in succession, each final panoramic or stereoscopic image, during each interval of time separating the beginning of two successive image capturing operations.

154. The device according to claim 153, wherein the final panoramic or stereoscopic image, generated during an interval of time separating the beginning of two successive image capturing operations, arises from the digital processing of pixels occurring during said same interval of time.

155. The device according to claim 153, wherein the final panoramic or stereoscopic image, generated during an interval of time separating the beginning of two successive image capturing operations, arises from the digital processing of pixels occurring during a preceding interval of time.

156. The device according to claim 148, wherein the digital processing means are designed to process each pixel, so that at least one part of the pixels from the captured images is mapped onto the final panoramic or stereoscopic image, after being submitted to a two dimensional projection that is different from the two dimensional projection of said same pixels, onto the image of the image capturing device from which they are derived.

157. The device according to claim 148, wherein the electronic processing means are designed to process several pixels from the captured images, by assigning to each one, several different positions on the final panoramic or stereoscopic image.

158. The device according to claim 148, wherein the electronic processing means are designed to process several pixels from the captured image, by assigning to each one, at least one position on the final panoramic or stereoscopic image, with a weighted factor that is not zero, and strictly less than 100%.

159. The device according to claim 148, comprising at least two image capturing devices.

160. The device according to claim 148, comprising at least three image capturing devices.

161. The device according to claim 148, wherein each of the image capturing devices is designed to deliver, as output, for each captured image, a stream of pixels synchronized according to, at least, a first clock signal, and in that the electronic processing means are suited to deliver each of the final panoramic or stereoscopic images as a stream of pixels, synchronized at least according to a second clock signal.

162. The device according to claim 161, wherein the second clock signal is asynchronous in comparison to each first clock signal.

163. The device according to claim 161, wherein the second clock signal is synchronous with the first clock signal(s).

164. The device according to claim 148, wherein the electronic means comprise a pre-stored Correspondence Table coding, for each pixel of a captured image, using at least one image capturing device, the corresponding position(s) of said pixel on the panoramic or stereoscopic image, and coding for each position said pixel on the final panoramic or stereoscopic image, with the weighted factor of said pixel on the final panoramic or stereoscopic image.

165. The device according to claim 148, wherein said device is portable.
